(19) United States
(12) Patent Application Publication
(10) Pub. No.: US 2014/0002434 A1
(43) Pub. Date: Jan. 2, 2014

(54) DISPLAY DEVICE

(71) Applicant: SAMSUNG DISPLAY CO., LTD., Yongin-City (KR)

(72) Inventors: Kyung-Ho PARK, Asan-si (KR); Soo-Hyun KIM, Chungju-si (KR); Jae Won KIM, Asan-si (KR); Dong-Hyun YOO, Asan-si (KR)

(73) Assignee: Samsung Display Co., Ltd., Yongin-City (KR)

(21) Appl. No.: 13/670,361

(22) Filed: Nov. 6, 2012

(30) Foreign Application Priority Data
Jul. 2, 2012 (KR) 10-2012-0071676

(51) Int. Cl. G09G 3/00

(52) U.S. Cl. CPC G09G 3/00
USPC 345/211

(57) ABSTRACT

A display device has a display region for displaying controlled images. The display device includes a common electrode overlapping the display region, a data driver, a first-category common voltage electrode set including a first-category common voltage electrode that is electrically connected to the data driver and is electrically connected to the common electrode, a second-category common voltage electrode set disposed farther from the data driver than the first-category common voltage electrode set and including a second-category common voltage electrode that is electrically connected to the data driver, a third-category common voltage electrode set disposed farther from the data driver than the second-category common voltage electrode set and including a third-category common voltage electrode that is electrically connected to the common electrode, and a common voltage line overlapping the display region and electrically connected between the second-category common voltage electrode and the third-category common voltage electrode.

### CROSS-REFERENCE TO RELATED APPLICATION

This application claims priority to and the benefit of Korean Patent Application No. 10-2012-0071676 filed in the Korean Intellectual Property Office on Jul. 2, 2012, the entire contents of which are incorporated herein by reference.

### BACKGROUND OF THE INVENTION

(a) Field of the Invention The present invention relates to a display device, and more particularly, to a display device with a minimized bezel size.

(b) Description of the Related Art

Display devices are usually required for computer monitors, televisions, mobile phones, etc. Examples of display devices include cathode ray tube displays, liquid crystal displays, plasma displays, etc.

As an example, a liquid crystal display typically includes two panels, on which field generating electrodes such as a pixel electrode and a common electrode are disposed, and a liquid crystal layer interposed therebetween. The liquid crystal display may display an image by applying a voltage to the field generating electrodes to generate an electric field in the liquid crystal layer, determining alignment of liquid crystal molecules of the liquid crystal layer, controlling polarization of incident light, etc.

A gate driver, a data driver, and/or other signal sources for applying signals to pixels may be disposed at an edge portion of a display device. The edge portion of the display device surrounds the display region of the display device, does not display images (e.g., images controlled by the liquid crystal layer), and may be called a bezel. Typically, one or more contact points for receiving one or more of the signals and one or more signal sources for supplying one or more of the signals may be disposed at opposite sides with respect to the display region in a plan view of the display device, and one or more connection lines may be disposed at the bezel for connecting the one or more contact points to the one or more signal sources. Given the existence of the one or more connection lines, a substantial width may be required for one or more portions of the bezel.

The above information disclosed in this Background section is only for enhancement of understanding of the background of the invention. The Background section may contain information that does not form the prior art that is already known in this country to a person of ordinary skill in the art.

### SUMMARY OF THE INVENTION

Embodiments of the present invention may be related to a display device having a minimized bezel width.

One or more embodiments of the invention may be related to a display device having a display region that is configured for displaying controlled images. The display device may include a common electrode overlapping the display region and configured to cooperate with pixel electrodes for controlling the images. The display device may further include a data driver set configured for providing common voltages, the data driver set including a first data driver. The display device may further include a first-category common voltage electrode set that includes a first-category common voltage electrode, the first-category common voltage electrode being electrically connected to the first data driver and being electrically connected to the common electrode. The display device may further include a second-category common voltage electrode set disposed farther from the data driver set than the first-category common voltage electrode set and including a second-category common voltage electrode, the second-category common voltage electrode being electrically connected to the first data driver. The display device may further include a third-category common voltage electrode set disposed farther from the data driver set than the second-category common voltage electrode set and including a third-category common voltage electrode, the third-category common voltage electrode being electrically connected to the common electrode. The display device may further include a first common voltage line overlapping the display region (in a direction perpendicular to the display region) and electrically connected between the second-category common voltage electrode and the third-category common voltage electrode.

The first common voltage line may overlap the display region instead of circumvent the display region. Advantageously, a bezel width for accommodating the first common voltage line may be minimized, and the display device may have a minimized bezel width.

In one or more embodiments, the display device may further include an insulating layer having a first hole and disposed between the first-category common voltage electrode and the common electrode. The display device may further include a connection electrode disposed through the first hole and electrically connected between the first-category common voltage electrode and the common electrode.

In one or more embodiments, the display device may further include an contact electrode electrically connected between the connection electrode and the common electrode.

In one or more embodiments, the display device may further include a passivation layer having a second hole and disposed between the insulating layer and the common electrode, wherein the second hole may be connected to the first hole, and wherein the connection electrode may be further disposed through the second hole.

In one or more embodiments, the display device may further include a first pixel electrode, a second pixel electrode immediately neighboring the first pixel electrode, a first data line associated with the first pixel electrode and disposed between the first pixel electrode and the second pixel electrode in a plan view of the display device, and a second data line electrically associated with the second pixel electrode and disposed between the first pixel electrode and the second pixel electrode in the plan view of the display device, wherein the first common voltage line may be disposed between the first data line and the second data line in the plan view of the display device.

In one or more embodiments, the display device may further include a shielding electrode, the shielding electrode being electrically connected to the first common voltage line, overlapping the first common voltage line, and being wider than the first common voltage line in a direction perpendicular to the first common voltage line.

In one or more embodiments, the shielding electrode may further overlap at least one of the first data line and the second data line.

In one or more embodiments, the display device may further include a third data line associated with the first pixel electrode, a second common voltage line electrically connected between the second-category common voltage electrode set and the third-category common voltage electrode set, wherein the first pixel electrode may be disposed between the first data line and the third data line in the plan view of the display device, and wherein the first data line and the third data line may be disposed between the first common voltage line and the second common voltage line in the plan view of the display device.

In one or more embodiments, the display device may further include a second common voltage line immediately neighboring the first common voltage line and electrically connected between the second-category common voltage electrode set and the third-category common voltage electrode set, and a plurality of pixel electrodes disposed between the first common voltage line and the second common voltage line and arranged along a direction that is perpendicular to the first common voltage line.

In one or more embodiments, the display device may further include a second common voltage line electrically connected between the second-category common voltage electrode and the third-category common voltage electrode.

In one or more embodiments, the data driver set may further include a second data driver, and the first-category common voltage electrode may be further electrically connected to the second data driver.

In one or more embodiments, the second-category common voltage electrode may be further electrically connected to the second data driver.

In one or more embodiments, a space disposed between the first data driver and the second data driver may overlap the first-category common voltage electrode in a direction parallel to the first common voltage line.

In one or more embodiments, the first-category common voltage electrode set may include at least two first-category common voltage electrodes that are electrically connected to the first data driver.

In one or more embodiments, the data driver set may include a plurality of data drivers electrically connected to the second-category common voltage electrode.

In one or more embodiments, the first-category common voltage electrode set may include a plurality of first-category common voltage electrodes, the second-category common voltage electrode set may include a plurality of second-category common voltage electrodes, and each of the plurality of first-category common voltage electrodes may be electrically connected to at least one same data driver in the data driver set as one of the plurality of second-category common voltage electrodes.

In one or more embodiments, the second-category common voltage electrode set may include a plurality of second-category common voltage electrodes, and the data driver set may be configured to simultaneously provide voltages having different magnitudes to the plurality of second-category common voltage electrodes.

In one or more embodiments, the second-category common voltage electrode set may include a plurality of second-category common voltage electrodes, the third-category common voltage electrode set may include a plurality of third-category common voltage electrodes, and each of the plurality of second-category common voltage electrodes may be electrically connected to exactly one of the plurality of third-category common voltage electrodes through one or more common voltage lines that overlap the display region.

One or more embodiments of the invention may be related to a display device having a display region that is configured for displaying controlled images. The display device may include a common electrode overlapping the display region, a data driver, a first common voltage electrode electrically connected to the data driver, a second common voltage electrode disposed farther from the data driver than the first common voltage electrode set and electrically connected to the common electrode, and a common voltage line overlapping the display region and electrically connected between the first common voltage electrode and the second common voltage electrode.

In one or more embodiments, the display device may further include an insulating layer having a hole and disposed between the first common voltage electrode and an end portion of the common voltage line; the display device may further include a connection electrode disposed through the hole and electrically connected between the first common voltage electrode and the end portion of the common voltage line.

One or more embodiments of the present invention may be related to a display device that includes the following elements: a first substrate and a second substrate including a display region and a non-display region and facing each other; a first common voltage electrode formed at a first edge on the first substrate; a second common voltage electrode formed on a lower side of the first common voltage electrode; a third common voltage electrode formed at a second edge facing the first edge on the first substrate; a common voltage line formed in the display region and connecting the second common voltage electrode and the third common voltage electrode; a common electrode formed on the second substrate; a first contact electrode formed between the first substrate and the second substrate and connecting the first common voltage electrode and the common electrode; and a second contact electrode formed between the first substrate and the second substrate and connecting the third common voltage electrode and the common electrode.

In one or more embodiments, the display device may further include the following elements: a first data line and a second data line formed in parallel on the first substrate, in which the first substrate may include a plurality of pixels disposed in a matrix form, the first data line and the second data line may be disposed at both edges of the plurality of pixels, each pixel may be connected to the first data line and the second data line, and the common voltage line may be formed between the first data line connected to any one pixel of the two adjacent pixels and the second data line connected to the other pixel.

The common voltage line may be formed in plural, and a plurality of first data lines and a plurality of second data lines may be disposed between the two adjacent common voltage lines.

In one or more embodiments, the display device may further include the following elements: a gate line formed to cross the first data line and the second data line; a first switching element connected to the gate line and the first data line; a second switching element connected to the gate line and the second data line; a first subpixel electrode connected to the first switching element to be formed in the pixel; and a second subpixel electrode connected to the second switching element to be formed in the pixel.

In one or more embodiments, the display device may further include the following elements: a first connection electrode connected to the first common voltage electrode and formed on the first common voltage electrode, in which the first contact electrode may be formed on the first connection electrode.

In one or more embodiments, the display device may further include the following elements: a gate insulating layer and a passivation layer formed on the first common voltage electrode; and a first contact hole formed in the gate insulating layer and the passivation layer so that at least a portion of the first common voltage electrode is exposed therethrough, in which the first connection electrode may be formed on the passivation layer so as to be connected through the first contact hole to the first common voltage electrode.

In one or more embodiments, the display device may further include the following elements: a data driver attached to the first edge on the first substrate, in which the first common voltage electrode may be connected to the data driver to receive a common voltage from the data driver.

The data driver and the first common voltage electrode may be formed in plural, and the plurality of first common voltage electrodes may be disposed so as to be spaced apart from each other between the plurality of data drivers.

In one or more embodiments, the display device may further include the following elements: a second connection electrode connected to the second common voltage electrode and the common voltage line and formed on the second common voltage electrode and the common voltage line.

In one or more embodiments, the display device may further include the following elements: a gate insulating layer formed on the second common voltage electrode; a passivation layer formed on the gate insulating layer and the common voltage line; a second contact hole formed in the gate insulating layer so that at least a portion of the second common voltage electrode is exposed therethrough; and a third contact hole formed in the gate insulating layer and the passivation layer so that an end of the common voltage line is exposed therethrough, in which the second connection electrode may be formed on the passivation layer so as to be connected through the second contact hole and the third contact hole to the second common voltage electrode and the common voltage line.

In one or more embodiments, the display device may further include the following elements: a data driver attached to the first edge on the first substrate, in which the second common voltage electrode may be connected to the data driver to receive the common voltage from the data driver.

In one or more embodiments, the display device may further include the following elements: a third connection electrode connected to the third common voltage electrode and the common voltage line and formed on the second common voltage electrode and the common voltage line.

In one or more embodiments, the display device may further include the following elements: a gate insulating layer formed on the third common voltage electrode; a passivation layer formed on the gate insulating layer and the common voltage line; a fourth contact hole formed in the gate insulating layer so that at least a portion of the third common voltage electrode is exposed therethrough; and a fifth contact hole formed in the gate insulating layer and the passivation layer so that the end of the common voltage line is exposed therethrough, in which the third connection electrode may be formed on the passivation layer so as to be connected through the fourth contact hole and the fifth contact hole to the third common voltage electrode and the common voltage line.

In one or more embodiments, the display device may further include the following elements: a fourth connection electrode connected to the third common voltage electrode and formed on the third common voltage electrode, in which the second contact electrode may be formed on the fourth connection electrode.

In one or more embodiments, the display device may further include the following elements: a gate insulating layer and a passivation layer formed on the third common voltage electrode; and a sixth contact hole formed in the gate insulating layer and the passivation layer so that at least a portion of the third common voltage electrode is exposed therethrough, in which the fourth connection electrode may be formed on the passivation layer so as to be connected through the sixth contact hole to the third common voltage electrode.

The second common voltage electrode and the third common voltage electrode may be formed in plural, and different common voltages may be applied to the plurality of second common voltage electrodes.

In one or more embodiments, the display device may further include the following elements: a shielding electrode connected to the common voltage line and formed so as to overlap the common voltage line and the first data line and the second data line adjacent to both sides of the common voltage line.

In one or more embodiments, the display device may further include the following elements: a passivation layer formed on the first data line, the second data line and the common voltage line; and a seventh contact hole formed in the passivation layer so that at least a portion of the common voltage line is exposed therethrough, in which the shielding electrode may be formed on the passivation layer so as to be connected through the seventh contact hole to the common voltage line.

One or more embodiments of the present invention may be related to a display device that includes the following elements: a first substrate and a second substrate including a display region and a non-display region and facing each other, the display region including a plurality of pixels; a first common voltage electrode formed at a first edge on the first substrate; a second common voltage electrode formed at a second edge facing the first edge on the first substrate; a common voltage line formed in the display region so that the first common voltage electrode and the second common voltage electrode are connected; a first data line and a second data line formed in parallel in the display region on the first substrate; a common electrode formed on the second substrate; and a first contact electrode formed between the first substrate and the second substrate and connecting the second common voltage electrode and the common electrode, in which first data line and the second data line are disposed at both edges of the plurality of pixels, each pixel is connected to the first data line and the second data line, and the common voltage line is formed between the first data line connected to any one pixel of the two adjacent pixels and the second data line connected to the other pixel.

In one or more embodiments, the display device may further include the following elements: a third common voltage electrode formed on an upper side of the first common voltage electrode; and a second contact electrode formed between the first substrate and the second substrate and connecting the third common voltage electrode and the common electrode.

Embodiments of the present invention may form common voltage electrodes at both edge portions of a first substrate and dispose a common voltage line connecting the electrodes. The common voltage line may be disposed between two adjacent pixels (in a plan view of the display device) and overlapping the display region without circumventing the display region, to minimize a bezel width. A common voltage may be transmitted through the common voltage line from a point to which the common voltage is applied to a point that is far away therefrom. Accordingly, it is possible to minimize the bezel width.

Embodiments of the invention may enable different common voltages having different magnitudes to be applied for different sub-regions of a display region. Advantageously, display characteristics may be fine-tuned, and flicker may be minimized.

In one or more embodiments, a shielding electrode overlapping the common voltage line may be implemented. Advantageously, distortion of the common voltage caused by a change in data voltage can be minimized.

### BRIEF DESCRIPTION OF THE DRAWINGS

FIG. 1 is a (top) plan view illustrating a display device according to one or more embodiments of the present invention.

FIG. 2 is a (top) plan view illustrating one pixel of a display device according to one or more embodiments of the present invention.

FIG. 3 is a (top) plan view illustrating two pixels of a display device according to one or more embodiments of the present invention.

FIG. 4 is a cross-sectional view of a display device according to one or more embodiments of the present invention, the cross-sectional view being taken along lines IV-IV′ and IV′-IV″ of FIG. 3.

FIG. 5 is a (top) plan view illustrating a first common voltage electrode of a display device and related elements according to one or more embodiments of the present invention.

FIG. 6 is a cross-sectional view of a display device according to one or more embodiments of the present invention, the cross-sectional view being taken along line VI-VI of FIG. 5.

FIG. 7 is a (top) plan view illustrating a second common voltage electrode of a display device and related elements according to one or more embodiments of the present invention.

FIG. 8 is a cross-sectional view of a display device according to one or more embodiments of the present invention, the cross-sectional view being taken along line VIII-VIII of FIG. 7.

FIG. 9 is a top plan view illustrating a third common voltage electrode of a display device and related elements according to one or more embodiments of the present invention.

FIG. 10 is a cross-sectional view of a display device according to one or more embodiments of the present invention, the cross-sectional view being taken along line X-X of FIG. 8.

FIG. 11 is a cross-sectional view of a display device according to one or more embodiments of the present invention, the cross-sectional view being taken along line XI-XI of FIG. 8.

FIG. 12 is a (top) plan view illustrating a display device according to one or more embodiment of the present invention.

FIG. 13 is a (top) plan view illustrating two pixels of a display device according to one or more embodiments of the present invention.

FIG. 14 is a cross-sectional view of a display device according to one or more embodiments of the present invention, the cross-sectional view being taken along lines XIV-XIV′ and XIV′-XIV″ of FIG. 13.

### DETAILED DESCRIPTION OF THE EMBODIMENTS

The present invention will be described more fully hereinafter with reference to the accompanying drawings, in which embodiments of the invention are illustrated. As those skilled in the art would realize, the described embodiments may be modified in various different ways, all without departing from the spirit or scope of the present invention.

In the drawings, the thicknesses of layers, films, panels, regions, etc. may be exaggerated for clarity. Like reference numerals may designate like elements throughout the specification. It will be understood that when an element such as a layer, film, region, or substrate is referred to as being “on” another element, it can be directly on the other element or intervening elements may also be present between the two elements. In contrast, when an element is referred to as being “directly on” another element, there are no intervening elements present between the two elements.

Although the terms first, second, third etc. may be used herein to describe various signals, elements, components, regions, layers, and/or sections, these signals, elements, components, regions, layers, and/or sections should not be limited by these terms. These terms may be used to distinguish one signal, element, component, region, layer, or section from another signal, region, layer or section. Thus, a first signal, element, component, region, layer, or section discussed below may be termed a second signal, element, component, region, layer, or section without departing from the teachings of the present invention. The description of an element as “first” does not imply that second or other elements are needed. The terms first, second, third etc. may also be used herein to differentiate different categories of elements. For conciseness, the terms first, second, third, etc. may represent first-category, second-category, third-category, etc., respectively.

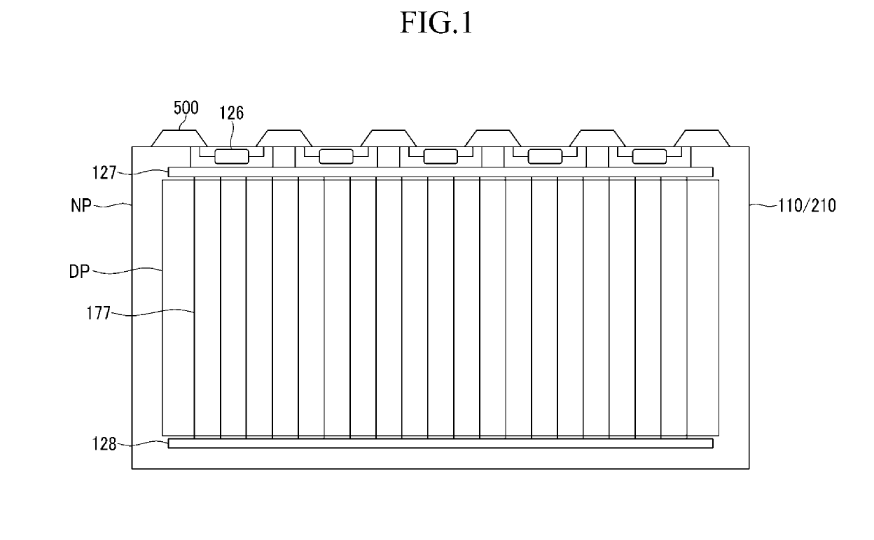

FIG. 1 is a (top) plan view illustrating a display device according to one or more embodiments of the present invention.

The display device may include a first substrate 110 and a second substrate 210 overlapping each other, a first-category common voltage electrode set (including at least one first-category common voltage electrode 126) and a second-category common voltage electrode set (including at least one second-category common voltage electrode 127) disposed at a first edge portion of the first substrate 110, a third-category common voltage electrode set (including at least one third-category common voltage electrode 128) disposed at a second edge portion of the first substrate 110, and a common voltage line set electrically connecting the second-category common voltage electrode set and the third-category common voltage electrode set. The common voltage line set may include one or more common voltage lines, such as a common voltage line 177 electrically connecting the second-category common voltage electrode 127 and the third-category common voltage electrode 128.

For conciseness, the first-category common voltage electrode set, the second-category common voltage electrode set, and the third-category common voltage electrode set may be called the first common voltage electrode set, the second common voltage electrode set, and the third common voltage electrode set, respectively. For conciseness, a first-category common voltage electrode 126, a second-category common voltage electrode, and third-category common voltage electrode 128 may be called a first common voltage electrode 126, a second common voltage electrode, and third common voltage electrode 128, respectively.

Each common voltage electrode set may include one or more common voltage electrodes. The one or more common voltage electrodes of one set may have configurations (e.g., dimensions, materials, and/or arrangements) that are different from configurations of the one or more common voltage electrodes of another set; e.g., configurations of a first common voltage electrode 126 may be different from configurations of a second common voltage electrode 128. Common voltage electrodes associated with the same reference numeral may have equivalent or analogous configurations; e.g., configurations of a common voltage electrode 126 may be equivalent to or analogous to configurations of another common voltage electrode 126. Each of the first substrate 110 and the second substrate 210 may be an insulating substrate formed of one or more of transparent glass, plastics, etc. A liquid crystal layer (not shown) may be formed between the first substrate 110 and the second substrate 210. Each of the first substrate 110 and the second substrate 210 may include a display region DP and a non-display region NP. The display region DP is a region where one or more images may be displayed and may be controlled by the liquid crystal layer when the display device is driven. The display region DP of the first substrate 110 is disposed between the first edge portion of the first substrate 110 and the second edge portion of the first substrate 110. The non-display region NP may include the first edge portion of the first substrate 110 and the second edge portion of the first substrate 110. The first edge portion of the first substrate 110 may represent, for example, an upper edge portion of the first substrate 110 according to a standing position of the display device.

The first(-category) common voltage electrode set may be called a substrate-edge common voltage electrode set, wherein a first(-category) common voltage electrode 126 may be called a substrate-edge common voltage electrode 126. The second(-category) common voltage electrode set may be called a DP-upper-edge common voltage electrode set, wherein a second(-category) common voltage electrode 127 may be called an DP-upper-edge common voltage electrode 127. The third(-category) common voltage electrode set may be called a DP-lower-edge common voltage electrode set, wherein a third(-category) common voltage electrode 128 may be called an DP-lower-edge common voltage electrode 128.

The first common voltage electrode set may include a plurality of first common voltage electrodes 126 spaced apart from each other at a predetermined interval along the first edge portion of the first substrate 110.

A data driver 500 may be attached to (and/or coupled with) the first edge portion of the first substrate 110. At least one first common voltage electrode 126 may be electrically connected to the data driver 500 and may receive a common voltage from the data driver 500. In one or more embodiments, a plurality of data drivers 500 may be spaced apart from each other at a predetermined interval along the first edge portion of the first substrate 110. One or more first common voltage electrodes 126 may overlap a space disposed between two immediately adjacent data drivers 500 in a direction parallel to an extending direction of a common voltage line 177. First common voltage electrodes 126 and data drivers 500 may be alternately disposed.

The number of data drivers 500 may be more than the number of first common voltage electrodes 126 by one. A first common voltage electrode 126 may be electrically connected to two (immediately adjacent) data drivers 500 respectively positioned at two sides with respect to the first common voltage electrode 126 (and immediately neighboring the first common voltage electrode 126).

A second common voltage electrode 127 may be disposed at the upper edge portion of the first substrate 110 according to the standing position of the display device. The second common voltage electrode 127 may be disposed at a lower side with respect to at least one first common voltage electrode 126 according to the standing position of the display device. The at least one first common voltage electrode 126 may be disposed between the second common voltage electrode 127 and an edge of the first substrate 110 in a plan view of the display device. The at least one first common voltage electrode 126 may be disposed between the second common voltage electrode 127 and at least one data driver 500 in the plan view of the display device. The second common electrode 127 may be disposed between the at least one first common voltage electrode 126 and the display region DP in the plan view of the display device. The second common voltage electrode 127 may be formed in an elongated rod shape. The second common voltage electrode 127 may be electrically connected to the data driver 500 and may receive a common voltage from the data driver 500.

A third common voltage electrode 128 may be formed at the second edge portion of the first substrate 110, for example, a lower edge of the first substrate 110 according to a standing position of the display device. The second common voltage electrode 127 and the third common voltage electrode 128 may be disposed at opposite edge portions of the first substrate 110. The display region DP of the first substrate 110 may be disposed between the second common voltage electrode 127 and the third common voltage electrode 128 in a plan view of the display device. The third common voltage electrode 128 may have an elongated rod shape. A length of the third common voltage electrode 128 may approximately correspond (and/or substantially equal) to a length of the second common voltage electrode 127.

The common voltage line 177 may extend from the upper edge portion of the first substrate 110 to the lower edge portion of the first substrate (according to a standing position of the display device). The second common voltage electrode 127 and the third common voltage electrode 128 may extend in parallel, and the common voltage line 177 may be extend in a direction that is vertical to each of the second common voltage electrode 127 and the third common voltage electrode 128. The common voltage line 177 may overlap the display region DP of the first substrate 110.

The common voltage line set may include a plurality of common voltage lines 177 disposed in parallel at a predetermined interval.

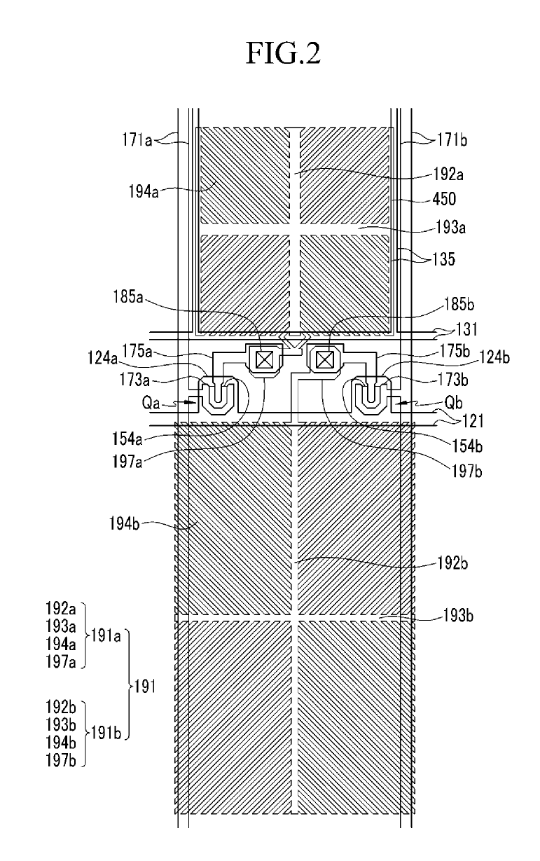

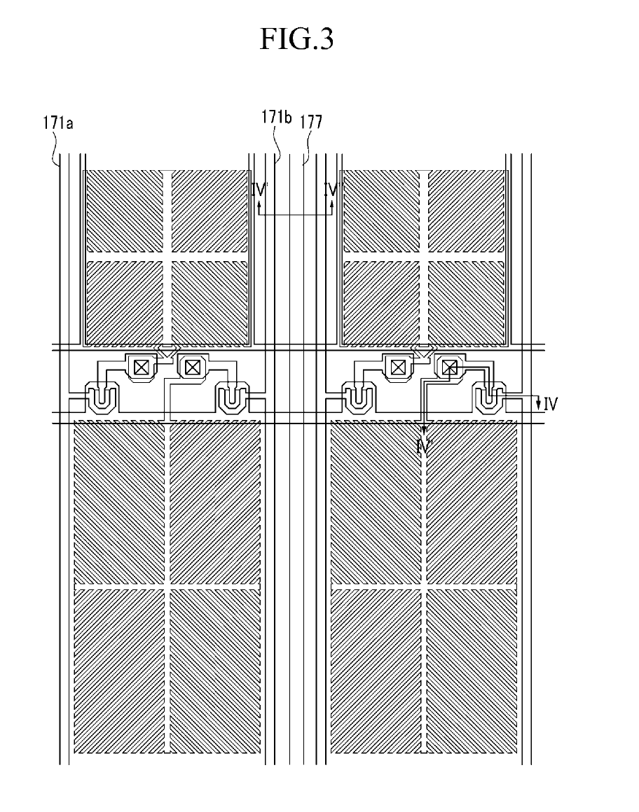

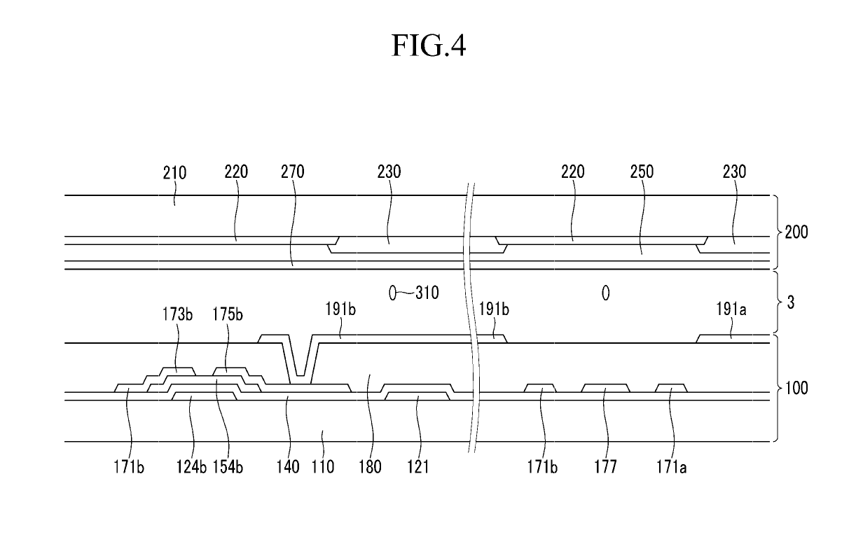

FIG. 2 is a (top) plan view illustrating one pixel of a display device according to one or more embodiments of the present invention, FIG. 3 is a (top) plan view illustrating two pixels of the display device according to one or more embodiments of the present invention, and FIG. 4 is a cross-sectional view of the display device according to one or more embodiments of the present invention, wherein the cross-sectional view is taken along lines IV-IV′ and IV′-IV″ of FIG. 3. Since the structure of each of the two pixels illustrated in FIG. 3 may be equivalent to the structure of the pixel illustrated in FIG. 2, some reference numerals may be omitted in FIG. 3.

Referring to FIGS. 2 to 4, the display device includes a lower panel 100 and an upper panel 200 that overlap each other, and a liquid crystal layer 3 interposed between two panels 100 and 200.

First, the lower panel 100 will be described.

A plurality of gate lines 121 and a plurality of storage electrode lines 131 and 135 are disposed on the first substrate 110.

The gate lines 121 may be parallel to and/or aligned with the second common voltage electrode 127 discussed with reference to FIG. 1 and/or the third common voltage electrode 128 discussed with reference to FIG. 1. A gate line 121 may transfer a gate signal. A first gate electrode 124a and a second gate electrode 124b may protrude from the gate line 121.

The storage electrode lines 131 and 135 include a branch line 131 extending in substantially parallel to the gate lines 121 and a plurality of storage electrodes 135 connected to the branch line 131. The storage electrode lines 131 and 135 act as a shielding electrode in a structure where an organic film is used in a lower portion of a pixel electrode 191. Distortion of a voltage charged in a first subpixel electrode 191 may be minimized by forming the storage electrode lines 131 and 135.

The shapes and disposal of the storage electrode lines 131 and 135 may be configured according to one or more of various forms.

A gate insulating layer 140 made of silicon nitride (SiNx) or silicon oxide (SiOx) is formed on the gate lines 121, the first gate electrode 124a, the second gate electrode 124b, and the storage electrode lines 131 and 135.

A plurality of semiconductors, including a first semiconductor 154a and a second semiconductor 154b and made of one or more of hydrogenated amorphous silicon (amorphous silicon is abbreviated to a-Si), polysilicon, etc., are formed on the gate insulating layer 140. The first semiconductor 154a overlaps the first gate electrode 124a, and the second semiconductor 154b overlaps the second gate electrode 124b.

A first data line 171a (or left-side data line 171a according to a standing position of the display device) and a second data line 171b (or right-side data line 171b according to the standing position of the display device) are associated with each of a plurality of pixels of the display device, are associated with each pixel column of a plurality of pixel columns of the display device, and extend in a second direction on the gate insulating layer 140. As illustrated in FIG. 3 and FIG. 4, a common voltage line 177 is disposed between the first data line 171a (associated with one pixel) and the second data line 171b (associated with another pixel). The first data line 171a, the second data line 171b, and the common voltage line 177 are formed in parallel, and are formed of the same material on the same layer.

The gate lines 121 may cross the data line 171a and 171b. The pixels are disposed in a matrix form on the first substrate 110. That is, a plurality of pixel columns and a plurality of pixel rows may be formed. A first (or left-side) data line 171a may be disposed at a left edge of each pixel column, and a second (or right-side) data line 171b may be disposed at a right edge of each pixel column. The common voltage line 177 may be disposed between two immediately adjacent pixel columns in a plan view of the display device. In one or more embodiments, the common voltage line 177 is positioned between the second data line 171b connected to the pixel positioned at the left side with respect to the common voltage line 177 and the first data line 171a connected to the pixel positioned at the right side with respect to the common voltage line in a plan view of the display device. A data line may be disposed between common voltage line immediately neighboring the data line and a pixel electrode immediately neighboring the data line in a plan view of the display device.

In one or more embodiments, a plurality of pixel columns may be disposed between two immediately adjacent common voltage lines 177. A plurality of first data lines 171a and a plurality of second data lines 171b associated with the pixel columns may be disposed between the two immediately adjacent common voltage lines 177.

In one or more embodiments, a common voltage line 177 may be disposed between each pair of two immediately adjacent pixel columns. In one or more embodiments, exactly one pixel column is disposed between two immediately adjacent common voltage lines 177.

The width of the common voltage line 177 may be at least two times that of the first data line 171a and/or the second data line 171b. Distortion of the common voltage caused by the data voltage applied to the first data line 171a and the second data line 171b may be minimized by configuring the common voltage line 177 to have the large width.

A first source electrode 173a (protruding from the first data line 171a over the first gate electrode 124a) and a first drain electrode 175a (spaced apart from the first source electrode 173a) are formed on the gate insulating layer 140. Further, a second source electrode 173b (protruding from the second data line 171b over the second gate electrode 124b) and a second drain electrode 175b (spaced apart from the second source electrode 173b) are formed on the gate insulating layer 140. The first source electrode 173a and the second source electrode 173b may have a U shape. Each of the drain electrodes 175a and 175b extends from an end that is partially surrounded by a corresponding one of the source electrodes 173a and 173b to another end, which may be relatively wider.

The first gate electrode 124a, the first source electrode 173a, and the first drain electrode 175a form a first switching element Qa together with the first semiconductor 154a. The second gate electrode 124b, the second source electrode 173b, and the second drain electrode 175b form a second switching element Qb together with the second semiconductor 154b. Channels of the first and the second switching elements Qa and Qb are formed on the first and the second semiconductors 154a and 154b between the first and the second source electrodes 173a and 173b and the first and the second drain electrodes 175a and 175b, respectively.

A passivation layer 180 is formed on the gate line 121, the first and the second data lines 171a and 171b, and the first and the second switching elements Qa and Qb. A first pixel contact hole 185a is formed so that at least a portion of the first drain electrode 175a is exposed therethrough, and a second pixel contact hole 185b is formed so that at least a portion of the second drain electrode 175b is exposed therethrough in the passivation layer 180.

A first subpixel electrode 191a connected through the first pixel contact hole 188a to the first drain electrode 175a is formed, and a second subpixel electrode 191b connected through the second pixel contact hole 188b to the second drain electrode 175b is formed on the passivation layer 180. The first subpixel electrode 191a is connected to the first switching element Qa, and the second subpixel electrode 191b is connected to the second switching element Qb. The first subpixel electrode 191a and the second subpixel electrode 191b are formed in one pixel, and separated from each other with the gate line 121 being interposed therebetween in a plan view of the display device. The first and the second subpixel electrodes 191a and 191b may be made of a transparent conductive material such as ITO or IZO, or reflective metal such as aluminum, silver, chromium, or an alloy thereof.

The whole first subpixel electrode 191a has a quadrangular shape, and includes a cross type stem portion formed of a vertical stem portion 192a and a horizontal stem portion 193a crossing the vertical stem portion 192a. The first subpixel electrode 191a is divided into four subregions by the horizontal stem portion 193a and the vertical stem portion 192a, and each subregion includes a plurality of fine branch portions 194a each extending in a diagonal and/or slanted direction. The widths of the horizontal stem portion 193a and the vertical stem portion 192a may be the same as or different from each other. A lower end protrusion portion 197a extending from a lower end of the vertical stem portion 192a overlaps the first drain electrode 175a.

The whole second subpixel electrode 191b has a quadrangular shape, and, similarly to the first subpixel electrode 191a, includes a cross type stem portion formed of a vertical stem portion 192b and a horizontal stem portion 193b crossing the vertical stem portion 192b. Further, similarly to the first subpixel electrode 191a, the second subpixel electrode 191b is divided into four subregions by the horizontal stem portion 193b and the vertical stem portion 192b, and each subregion includes a plurality of fine branch portions 194b each extending in a diagonal and/or slanted direction. The widths of the horizontal stem portion 193a and the vertical stem portion 192a may be the same as or different from each other. An upper end protrusion portion 197b extending from an upper end of the vertical stem portion 192b of the second subpixel electrode 191b overlaps the second drain electrode 175b.

An area of the first subpixel electrode 191a may be smaller than that of the second subpixel electrode 191b.

The first and the second subpixel electrodes 191a and 191b each receives a data voltage from the corresponding one of the first and the second data lines 171a and 171b when the corresponding one of the first and the second switching elements Qa and Qb is in an on-state.

A common electrode 270 is formed on the second substrate 210 of the display device according to one or more embodiments of the present invention. The common electrode 270 is made of a transparent conductor such as ITO or IZO, and receives a common voltage.

A light blocking member 220 and a color filter 230 may further be provided between the second substrate 210 and the common electrode 270. The color filter 230 is formed in a pixel area, and may be formed of a red color filter, a green color filter, a blue color filter, and the like. The light blocking member 220 may be formed in an area between pixel areas and an upper portion of a thin film transistor. A overcoat 250 may further be formed on the light blocking member 220 and the color filter 230, and the common electrode 270 may be formed on the overcoat 250.

The first and the second subpixel electrodes 191a and 191b, to which the data voltage is applied, generate an electric field together with the common electrode 270, to which the common voltage is applied, thus determining a direction of liquid crystal molecules (e.g., a liquid crystal molecule 310) of the liquid crystal layer 3 formed between the first substrate 110 and the second substrate 210. Luminance of light passing through the liquid crystal layer is changed according to the thusly determined direction of the liquid crystal molecules.

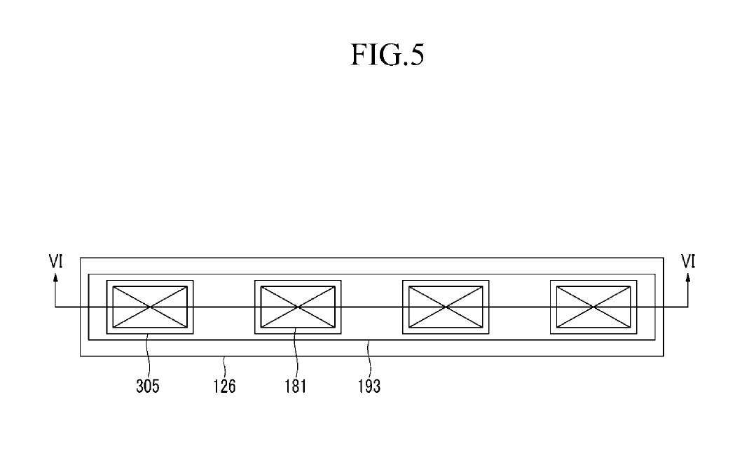

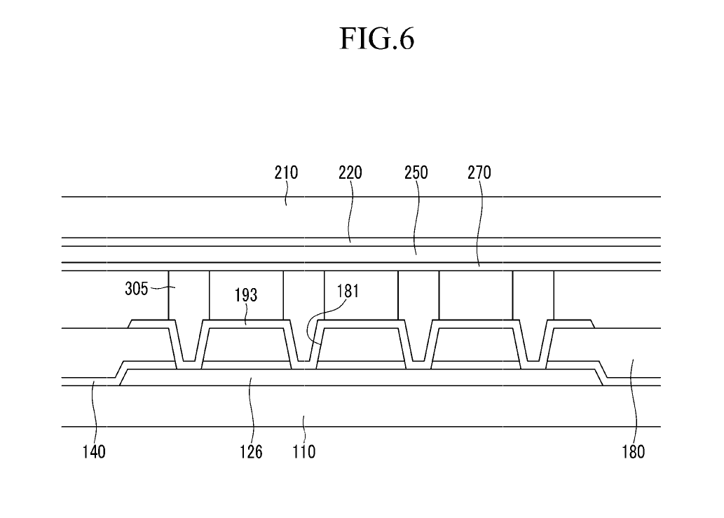

FIG. 5 is a (top) plan view illustrating a first common voltage electrode of a display device and related elements according to one or more embodiment of the present invention, and FIG. 6 is a cross-sectional view of the display device according to one ore more one or more embodiment of the present invention, wherein the cross-sectional view is taken along line VI-VI of FIG. 5.

The gate insulating layer 140 and the passivation layer 180 are formed on (and/or overlap) the first common voltage electrode 126 of the display device according to one or more embodiments of the present invention. The gate insulating layer 140 and the passivation layer 180 are formed in a non-display region (NP of FIG. 1) as well as a display region (DP of FIG. 1) on the first substrate 110.

A first contact hole 181 is formed in (and/or through) the gate insulating layer 140 and the passivation layer 180 so that at least a portion of the first common voltage electrode 126 is exposed therethrough. A plurality of first contact holes 181 may be formed on one first common voltage electrode 126.

A first connection electrode 193 connected through the first contact hole 181 to the first common voltage electrode 126 is formed on the passivation layer 180. The number of first connection electrodes 193 may be the same as the number of first common voltage electrodes 126. The first connection electrode 193 may be formed of the same material as the first subpixel electrode (191a of FIG. 2) and the second subpixel electrode (191b of FIG. 2).

A first contact electrode 305 for electrically connecting the first common voltage electrode 126 and the common electrode 270 is formed between the first substrate 110 and the second substrate 210. The first contact electrode 305 may be formed on the first connection electrode 193, and when the first substrate 110 and the second substrate 210 adhere to each other, the first contact electrode 305 may contact the common electrode 270. Since the first connection electrode 193 is connected through the first contact hole 181 to the first common voltage electrode 126, the first contact electrode 305 is electrically connected to the first common voltage electrode 126. Accordingly, the common voltage applied to the first common voltage electrode 126 is transferred through the first contact electrode 305 to the common electrode 270.

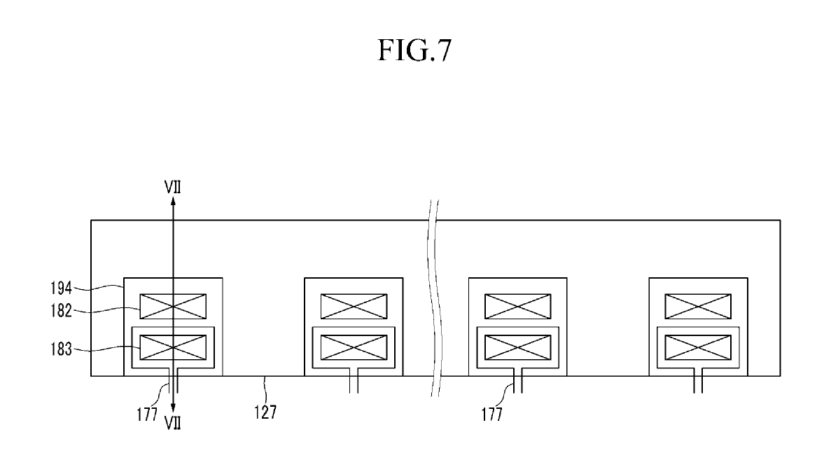

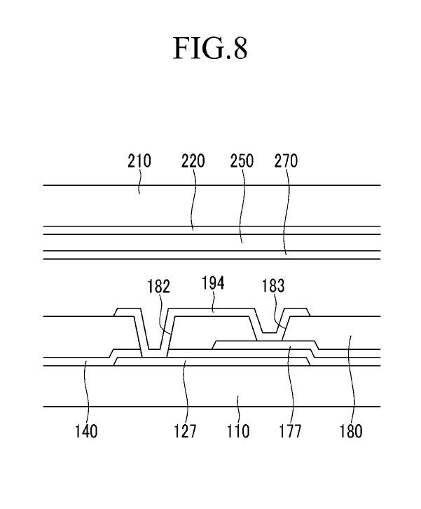

FIG. 7 is a (top) plan view illustrating a second common voltage electrode of the display device and related elements according to one or more embodiment of the present invention, and FIG. 8 is a cross-sectional view of the display device according to one or more embodiments of the present invention, wherein the cross-sectional view is taken along line VIII-VIII of FIG. 7.

The gate insulating layer 140 and the passivation layer 180 are formed on the second common voltage electrode 127 of the display device according to one or more embodiments of the present invention.

A second contact hole 182 is formed in (and/or through) the gate insulating layer 140 and the passivation layer 180 so that at least a portion of the second common voltage electrode 127 is exposed therethrough. A plurality of second contact holes 182 may be formed on one second common voltage electrode 127.

A third contact hole 183 is formed in (and/or through) the passivation layer 180 so that at least a portion of the common voltage line 177 is exposed therethrough. Particularly, the third contact hole 183 may be formed so that an upper end of the common voltage line 177 (according to a standing position of the display device) is exposed therethrough, and one third contact hole 183 may be formed on one common voltage line 177.

The upper end of the common voltage line 177 may be formed to be adjacent to the second common voltage electrode 127. Particularly, the upper end of the common voltage line 177 may be formed on and/or overlap the second common voltage electrode 127, with the gate insulating layer 140 being disposed between the upper end of the common voltage line 177 and the second common voltage electrode 127.

A second connection electrode 194 connected through the second contact hole 182 to the second common voltage electrode 127 and connected through the third contact hole 183 to the common voltage line 177 is formed on the passivation layer 180. The second connection electrode 194 may electrically connect the second common voltage electrode 127 to the common voltage line 177. The number of second connection electrodes 194 may be the same as the number of common voltage lines 177. The second connection electrode 194 may be formed of the same material as the first subpixel electrode (191a of FIG. 2) and the second subpixel electrode (191b of FIG. 2).

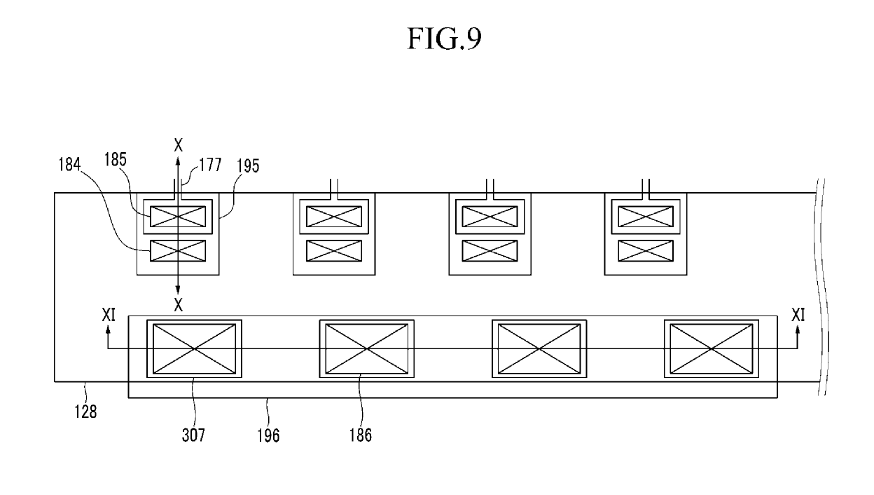

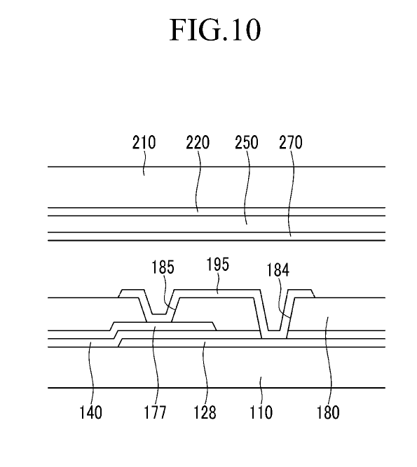

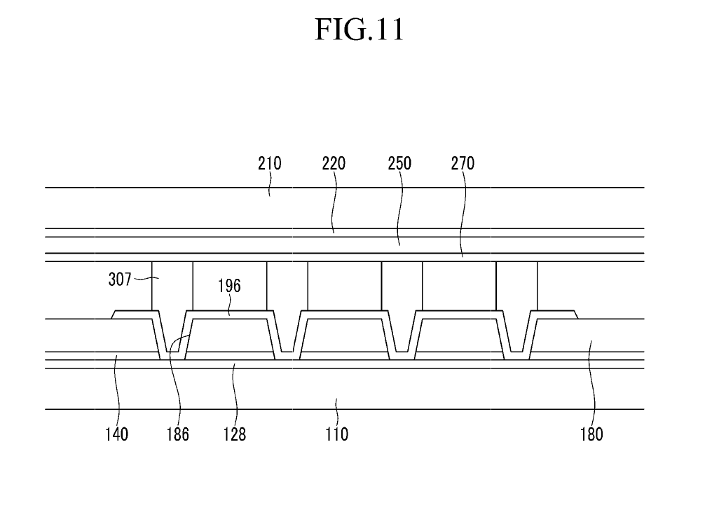

FIG. 9 is a (top) plan view illustrating a third common voltage electrode of a display device according to one or more embodiments of the present invention, FIG. 10 is a cross-sectional view of the display device according to one or more embodiments of the present invention and taken along line X-X of FIG. 8, and FIG. 11 is a cross-sectional view of the display device according to one or more embodiments of the present invention and taken along line XI-XI of FIG. 8.

The gate insulating layer 140 and the passivation layer 180 are formed on the third common voltage electrode 128 of the display device according to one or more embodiments of the present invention.

A fourth contact hole 184 is formed in (and/or through) the gate insulating layer 140 and the passivation layer 180 so that at least a portion of the third common voltage electrode 128 is exposed therethrough. A plurality of fourth contact holes 184 may be formed on the third common voltage electrode 128.

A fifth contact hole 185 is formed in (and/or through) the passivation layer 180 so that at least a portion of the common voltage line 177 is exposed therethrough. Particularly, the fifth contact hole 185 may be formed so that a lower end of the common voltage line 177 (according to a standing position of the display device) is exposed therethrough, and one fifth contact hole 185 may be formed on one common voltage line 177.

The lower end of the common voltage line 177 may be formed to be adjacent to the third common voltage electrode 128. Particularly, the lower end of the common voltage line 177 may be formed on and/or overlap the third common voltage electrode 128, with the gate insulating layer 140 being disposed between the lower end of the common voltage line 177 and the third common voltage electrode 128.

A third connection electrode 195 connected through the fourth contact hole 184 to the third common voltage electrode 128 and connected through the fifth contact hole 185 to the common voltage line 177 is formed on the passivation layer 180. The third connection electrode 195 may electrically connect the third common voltage electrode 128 to the common voltage line 177. The number of third connection electrodes 195 may be the same as the number of common voltage lines 177. The third connection electrode 195 may be formed of the same material as the first subpixel electrode (191a of FIG. 2) and the second subpixel electrode (191b of FIG. 2).

A sixth contact hole 186 is formed in (and/or through) the gate insulating layer 140 and the passivation layer 180 so that at least a portion of the third common voltage electrode 128 is exposed therethrough. A plurality of sixth contact holes 186 may be formed on one third common voltage electrode 128. The fourth contact hole 184 may be formed at an upper portion of the third common voltage electrode 128 (according to a standing position of the display device), and the sixth contact hole 186 may be formed at a lower side of the third common voltage electrode 128 (according to the standing position of the display device).

A fourth connection electrode 196 connected through the sixth contact hole 186 to the third common voltage electrode 128 is formed on the passivation layer 180. A plurality of fourth connection electrodes 196 may be formed on the passivation layer 180 and may be electrically connected to the third common voltage electrode 128. The fourth connection electrode 196 may be formed of the same material as the first subpixel electrode (191a of FIG. 2) and the second subpixel electrode (191b of FIG. 2).

A second contact electrode 307 connecting the third common voltage electrode 128 and the common electrode 270 is formed between the first substrate 110 and the second substrate 210. The second contact electrode 307 may be formed on the fourth connection electrode 196, and when the first substrate 110 and the second substrate 210 adhere to each other, the second contact electrode 307 may contact the common electrode 270. Since the fourth connection electrode 196 is connected through the sixth contact hole 186 to the third common voltage electrode 128, the second contact electrode 307 is electrically connected to the third common voltage electrode 128. Accordingly, the common voltage applied to the second common voltage electrode 127 is applied through the common voltage line 177 to the third common voltage electrode 128, and is transmitted through the second contact electrode 307 to the common electrode 270.

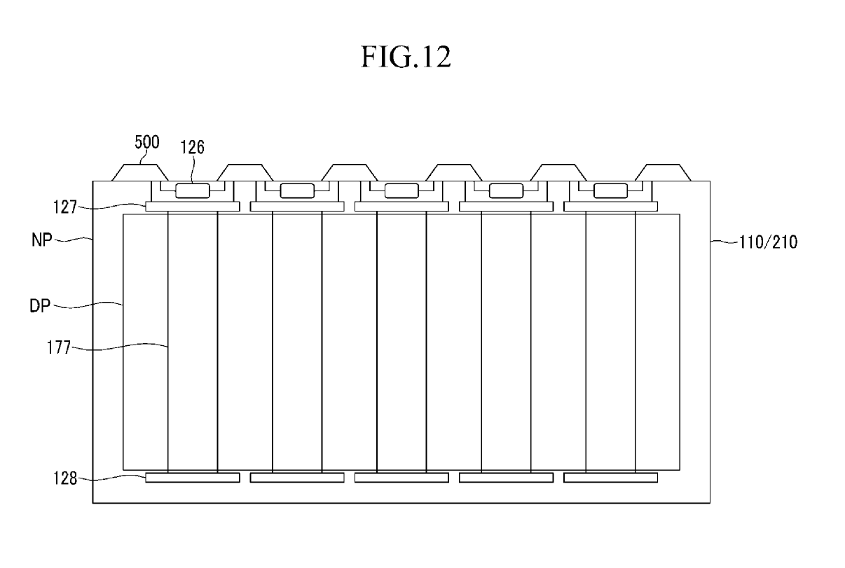

FIG. 12 is a (top) plan view of the display device according to one or more embodiments of the present invention.

The display device may include a first substrate 110 and a second substrate 210 overlapping each other, a first common voltage electrode set (including at least one first common voltage electrode 126) and a second common voltage electrode set (including at least one second common voltage electrode 127) formed at a first edge portion of the first substrate 110, a third common voltage electrode set (including at least one third common voltage electrode 128) formed at a second edge portion of the first substrate 110, and a common voltage line set electrically connecting the second-category common voltage electrode set and the third-category common voltage electrode set. The common voltage line set may include one or more common voltage lines, such as a common voltage line 177 electrically connecting the second common voltage electrode 127 and the third common voltage electrode 128.

The first common voltage electrode set may include a plurality of first common voltage electrodes 126, and common voltages (simultaneously) applied to the plurality of first common voltage electrodes 126 may have different values. For example, one first common voltage electrode 126 may receive a common voltage having a first value, and simultaneously another first common voltage electrode 126 may receive a common voltage having a second value that is different from the first value.

The second common voltage electrode set may include a plurality of second common voltage electrodes 127. The number of second common voltage electrodes 127 may be substantially equal to the number of first common voltage electrodes 126, and may be less than the number of data drivers 500 by one. A plurality of second common voltage electrodes 127 may be each disposed on lower sides with respect to a plurality of first common voltage electrodes 126. One or more second common voltage electrode 127 may overlap a space disposed between two immediately adjacent data drivers 500 in a direction parallel to an extending direction of a common voltage line 177. One or more first common voltage electrode 126 may be disposed between the space and the one or more second common voltage electrode 127. Second common voltage electrodes 127 and data drivers 500 may be alternately disposed.

A second common voltage electrode 127 may be electrically connected to two (immediately adjacent) data drivers 500 respectively positioned at two sides with respect to the second common voltage electrode 127 (and immediately neighboring the second common voltage electrode 127). A second common voltage electrode 127 may receive one or more common voltages from one or two data drivers 500. Common voltages applied to a plurality of second common voltage electrodes 127 may have different values.

Common voltages having the same value may be applied to a first common voltage electrode 126 and a second common voltage electrode 127 that are vertically adjacent to each other (i.e., aligned in a direction parallel to an extending direction of a common voltage line 177). For example, the common voltages applied to the first common voltage electrode 126 positioned at the leftmost side of the first common voltage electrode set and the second common voltage electrode 127 positioned at the leftmost side of the second common voltage electrode set have the same value.

The third common voltage electrode set may include a plurality of third common voltage electrodes 128. The number of third common voltage electrodes 128 may be substantially equal to the number of second common voltage electrodes 127.

One or more common voltage line 177 electrically connects a second common voltage electrode 127 and a third common voltage electrode 128. For example, as illustrated in FIG. 12, a second common voltage electrode 127 may be electrically connected through two common voltage lines to a third common voltage electrode 128. A common voltage line 177 may overlap the display region DP. A common voltage line 177 may (perpendicularly) cross a first boundary of the display region DP (e.g., an upper boundary of DP according to a standing position of the display device) and may (perpendicularly) cross a second boundary of the display region DP (e.g., a lower boundary of DP according to the standing position of the display device). Each of the first boundary and the second boundary is a boundary between the display region DP and the non-display region NP.

The display device may be divided into a plurality of regions according to the different magnitudes (or values) of common voltages applied to first common voltage electrodes 126 disposed at different positions and applied to second common voltage electrodes 127 disposed at different positions. The pixels positioned in a plurality of regions have different characteristics. In the display device according to one or more embodiments of the present invention, it is possible to compensate for a difference between regional characteristics by finely controlling the magnitudes (or values) of common voltages for different regions.

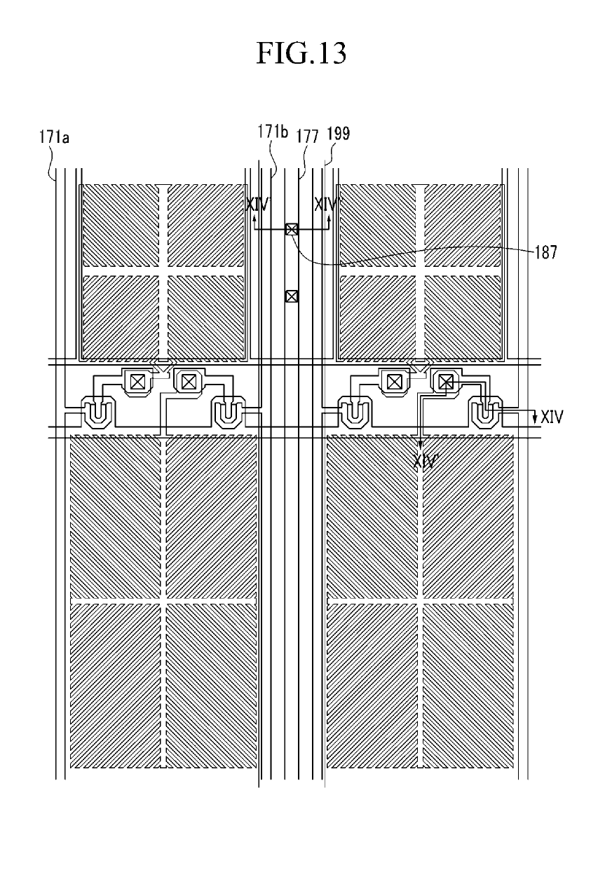

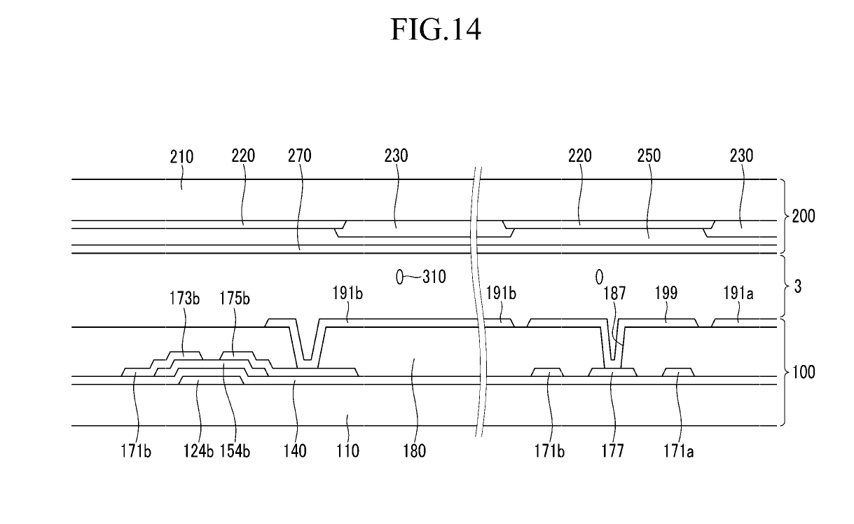

FIG. 13 is a (top) plan view illustrating two pixels of a display device according to one or more embodiments of the present invention, and FIG. 14 is a cross-sectional view of the display device according to one or more embodiments of the present invention, wherein the cross-sectional view is taken along lines XIV-XIV′ and XIV′-XIV″ of FIG. 13.

In the display device, a seventh contact hole 187 is formed in the passivation layer 180 so that at least a portion of the common voltage line 177 is exposed therethrough. A shielding electrode 199 is formed on the passivation layer 180 so as to be connected through the seventh contact hole 187 to the common voltage line 177.

The shielding electrode 199 may overlap the common voltage line 177. The shielding electrode 199 may further overlap one or more of the first data line 171a and the second data line 171b that are (immediately) adjacent to the common voltage line 177. Advantageously, distortion of the common voltage caused by the data voltage applied to the first data line 171a and the second data line 171b may be substantially minimized by the shielding electrode 199, which has a width that is larger than that of the common voltage line 177.

In one more embodiments, one shielding electrode 199 may be formed to overlap one common voltage line 177. In one or more embodiments, a plurality of shielding electrodes 199 overlapping one common voltage line 177 may be formed. One shielding electrode 199 may correspond to one pixel row and may overlap one common voltage line 177.

The shielding electrode 199 may be formed of the same material as the first subpixel electrode 191a and the second subpixel electrode 191b.

While this invention has been described in connection with what is presently considered to be practical embodiments, it is to be understood that the invention is not limited to the disclosed embodiments. The invention is intended to cover various modifications and equivalent arrangements included within the spirit and scope of the appended claims.

<Description of symbols>

| | |
|---|---|
| 110: First substrate | 121: Gate line |
| 124a: First gate electrode | 124b: Second gate electrode |
| 126: First common voltage electrode | |
| 127: Second common voltage | |
| electrode | |
| 128: Third common voltage electrode | |
| 140: Gate insulating layer | |
| 154a: First semiconductor | 154b: Second semiconductor |
| 171a: First data line | 171b: Second data line |
| 173a: First source electrode | 173b: Second source electrode |
| 175a: First drain electrode | 175b: Second drain electrode |
| 177: Common voltage line | 180: Passivation layer |
| 181: First contact hole | 182: Second contact hole |
| 183: Third contact hole | 184: Fourth contact hole |
| 185: Fifth contact hole | 186: Sixth contact hole |
| 191a: First subpixel electrode | 191b: Second subpixel electrode |
| 193: First connection electrode | 194: Second connection electrode |
| 195: Third connection electrode | 196: Fourth connection electrode |
| 199: Shielding electrode | 210: Second substrate |
| 270: Common electrode | 305: First contact electrode |
| 307: Second contact electrode | 500: Data driver |

What is claimed is:

1. A display device having a display region that is configured for displaying controlled images, the display device comprising:
a common electrode overlapping the display region;
a data driver set including a first data driver;
a first-category common voltage electrode set including a first-category common voltage electrode, the first-category common voltage electrode being electrically connected to the first data driver and being electrically connected to the common electrode;
a second-category common voltage electrode set disposed farther from the data driver set than the first-category common voltage electrode set and including a second-category common voltage electrode, the second-category common voltage electrode being electrically connected to the first data driver;
a third-category common voltage electrode set disposed farther from the data driver set than the second-category common voltage electrode set and including a third-category common voltage electrode, the third-category common voltage electrode being electrically connected to the common electrode; and
a first common voltage line overlapping the display region and electrically connected between the second-category common voltage electrode and the third-category common voltage electrode.

2. The display device of claim 1, further comprising:
an insulating layer having a first hole and disposed between the first-category common voltage electrode and the common electrode; and
a connection electrode disposed through the first hole and electrically connected between the first-category common voltage electrode and the common electrode.

3. The display device of claim 2, further comprising:
an contact electrode electrically connected between the connection electrode and the common electrode.

4. The display device of claim 2, further comprising:
a passivation layer having a second hole and disposed between the insulating layer and the common electrode,
wherein the second hole is connected to the first hole, and
wherein the connection electrode is further disposed through the second hole.

5. The display device of claim 1, further comprising:
a first pixel electrode;
a second pixel electrode immediately neighboring the first pixel electrode;
a first data line associated with the first pixel electrode and disposed between the first pixel electrode and the second pixel electrode in a plan view of the display device; and
a second data line electrically associated with the second pixel electrode and disposed between the first pixel electrode and the second pixel electrode in the plan view of the display device,
wherein the first common voltage line is disposed between the first data line and the second data line in the plan view of the display device.

6. The display device of claim 5, further comprising a shielding electrode, the shielding electrode being electrically connected to the first common voltage line, overlapping the first common voltage line, and being wider than the first common voltage line in a direction perpendicular to the first common voltage line.

7. The display device of claim 6, wherein the shielding electrode further overlaps at least one of the first data line and the second data line.

8. The display device of claim 5, further comprising:
a third data line associated with the first pixel electrode; and
a second common voltage line electrically connected between the second-category common voltage electrode set and the third-category common voltage electrode set,
wherein the first pixel electrode is disposed between the first data line and the third data line in the plan view of the display device, and
wherein the first data line and the third data line are disposed between the first common voltage line and the second common voltage line in the plan view of the display device.

9. The display device of claim 1, further comprising:
a second common voltage line immediately neighboring the first common voltage line and electrically connected between the second-category common voltage electrode set and the third-category common voltage electrode set; and
a plurality of pixel electrodes disposed between the first common voltage line and the second common voltage line and arranged along a direction that is perpendicular to the first common voltage line.

10. The display device of claim 1, further comprising:
a second common voltage line electrically connected between the second-category common voltage electrode and the third-category common voltage electrode.

11. The display device of claim 1,
wherein the data driver set further includes a second data driver, and
wherein the first-category common voltage electrode is further electrically connected to the second data driver.

12. The display device of claim 9, wherein the second-category common voltage electrode is further electrically connected to the second data driver.

13. The display device of claim 9, wherein a space disposed between the first data driver and the second data driver overlaps the first-category common voltage electrode in a direction parallel to the first common voltage line.

14. The display device of claim 1, wherein the first-category common voltage electrode set includes at least two first-category common voltage electrodes that are electrically connected to the first data driver.

15. The display device of claim 1, wherein the data driver set includes a plurality of data drivers electrically connected to the second-category common voltage electrode.

16. The display device of claim 1,
wherein the first-category common voltage electrode set includes a plurality of first-category common voltage electrodes,
wherein the second-category common voltage electrode set includes a plurality of second-category common voltage electrodes, and
wherein each of the plurality of first-category common voltage electrodes is electrically connected to at least one same data driver in the data driver set as one of the plurality of second-category common voltage electrodes.

17. The display device of claim 1,
wherein the second-category common voltage electrode set includes a plurality of second-category common voltage electrodes, and
wherein the data driver set is configured to simultaneously provide voltages having different magnitudes to the plurality of second-category common voltage electrodes.

18. The display device of claim 1,
wherein the second-category common voltage electrode set includes a plurality of second-category common voltage electrodes,
wherein the third-category common voltage electrode set includes a plurality of third-category common voltage electrodes, and
wherein each of the plurality of second-category common voltage electrodes is electrically connected to one of the plurality of third-category common voltage electrodes through one or more common voltage lines that overlap the display region.

19. A display device having a display region that is configured for displaying controlled images, the display device comprising:
a common electrode overlapping the display region;
a data driver;
a first common voltage electrode electrically connected to the data driver;
a second common voltage electrode disposed farther from the data driver than the first common voltage electrode set and electrically connected to the common electrode; and
a common voltage line overlapping the display region and electrically connected between the first common voltage electrode and the second common voltage electrode.

20. The display device of claim 19, further comprising:
an insulating layer having a hole and disposed between the first common voltage electrode and an end portion of the common voltage line; and
a connection electrode disposed through the hole and electrically connected between the first common voltage electrode and the end portion of the common voltage line.
